(19) United States
(12) Patent Application Publication
(10) Pub. No.: US 2025/0088084 A1
(43) Pub. Date: Mar. 13, 2025

(54) DEBURRING GAUGE FOR STATOR OF AN ELECTRIC MOTOR

(71) Applicant: Ford Global Technologies, LLC, Dearborn, MI (US)

(72) Inventors: Franco Leonardi, Dearborn Heights, MI (US); Michael W. Degner, Novi, MI (US)

(73) Assignee: Ford Global Technologies, LLC, Dearborn, MI (US)

(21) Appl. No.: 18/463,537

(22) Filed: Sep. 8, 2023

(51) Int. Cl. H02K 15/00; B25J 11/00; H02K 15/02

(52) U.S. Cl. CPC H02K 15/50; B25J 11/006; H02K 15/021

(57) ABSTRACT

A deburring gauge system that includes a gauge set, a gauge holder secured to the gauge set, and a controller. The gauge set is configured to be at least partially inserted into a slot set of a stator. Each gauge part of the gauge set includes a body having a shape that corresponds to a shape of a respective slot of the slot set. The body of each gauge part includes an abrasive portion extending along a length of the body. The controller is in communication with the gauge holder and configured to move the gauge holder in a first direction toward the stator so that the abrasive portion of the body is at least partially inserted into the respective slot and move the gauge holder in a second direction away from the stator so that the abrasive portion of the body is removed from the respective slot.

### FIELD

The present disclosure relates to a deburring gauge for a stator of an electric motor.

### BACKGROUND

The statements in this section merely provide background information related to the present disclosure and may not constitute prior art.

Electric machines (e.g., electric motors and generators) may be used in a vehicle such as a fully electric vehicle or a hybrid-electric vehicle. The electric machine includes, inter alia, a stator and a rotor. The rotor is supported for rotation within a bore of the stator and includes windings or permanent magnets that interact with windings of the stator to generate rotation of the rotor when the electric machine is energized. The rotor may be supported on a driveshaft that is configured to couple with a load such as a drivetrain of the vehicle.

The stator may go through a manufacturing process in which parts of the stator are insulated by a molding process. Upon completion of the molding process, the dimension of the slots of the stator are measured to provide for the slots being within predetermined tolerance ranges. Gauges may be used to measure the dimensions of the slots. Furthermore, burrs leftover from the molding process may need to be removed from the slots of the stator. Conventionally, the burrs are removed from the slots of the stator using a manual process.

### SUMMARY

This section provides a general summary of the disclosure and is not a comprehensive disclosure of its full scope or all of its features.

In one form, the present disclosure provides a deburring gauge system for a stator that includes a gauge set, a gauge holder, and a controller. The gauge set is configured to be at least partially inserted into a slot set of the stator. Each first gauge part of the gauge set includes a first body having a first cross-sectional shape that corresponds to a second cross-sectional shape of a respective first slot of the slot set. The first body of each first gauge part includes an abrasive portion extending along a length of the first body. The gauge holder is secured to the gauge set. The controller is in communication with the gauge holder and is configured to move the gauge holder in a first direction toward the stator so that the abrasive portion of the first body is at least partially inserted into the respective first slot of the slot set of the stator, and move the gauge holder in a second direction away from the stator so that the abrasive portion of the first body is removed from the respective first slot of the slot set of the stator.

In variations of the deburring gauge system of the above paragraph, which can be implemented individually or in any combination: the abrasive portion includes a series of ridges or a removable sandpaper structure; the abrasive portion includes a series of ridges and a removable sandpaper structure; each first gauge part of the gauge set includes an end extending from the first body, the end is tapered in the first direction; the controller is configured to move the gauge set in a reciprocating motion when the abrasive portion of the first body is at least partially inserted into the respective first slot of the slot set of the stator; the first body includes a non-abrasive portion extending along the length of the first body, the abrasive portion extends along the length of the first body a first distance and the non-abrasive portion extends along the length of the first body a second distance that is greater than the first distance; the first cross-sectional shape of each first gauge part of the gauge set is rectangular; the gauge set further includes second gauge parts secured to another gauge holder, each second gauge part configured to be inserted into the respective first slot of the slot set, each second gauge part includes a second body having a third cross-sectional shape that corresponds to the second cross-sectional shape of the respective first slot of the slot set; and a length of the second body of each second gauge part is greater than the length of the first body of each first gauge part.

In another form, the present disclosure provides a deburring gauge system for a stator that includes a first gauge set, a second gauge set, a first gauge holder, a second gauge holder, and a controller. The first gauge set is configured to be at least partially inserted into a slot set of the stator. Each first gauge part of the first gauge set includes a first body having a first cross-sectional shape that corresponds to a second cross-sectional shape of a respective slot of the slot set. The first body of each first gauge part includes an abrasive portion extending along a length of the first body. The second gauge set is configured to be at least partially inserted into the slot set of the stator. Each second gauge part of the second gauge set includes a second body having a third cross-sectional shape that corresponds to the second cross-sectional shape of the respective slot of the slot set. The first gauge holder is secured to the first gauge set. The second gauge holder is secured to the second gauge set. The controller is in communication with the first gauge holder and the second gauge holder. The controller configured to move the first gauge holder toward the stator so that the abrasive portion of the first body of each first gauge part is at least partially inserted into the respective slot of the slot set, move the first gauge holder away from the stator so that the abrasive portion of the first body of each first gauge part is removed from the respective slot of the slot set, move the second gauge holder toward the stator so that the second body of each second gauge part is at least partially inserted into the respective slot of the slot set, the second gauge holder being moved toward the stator after the abrasive portion of the first body of each first gauge part is removed from the respective slot of the slot set, and move the second gauge holder away from the stator so that the second body of each second gauge part is removed from the respective slot of the slot set.

In variations of the deburring gauge system of the above paragraph, which can be implemented individually or in any combination: the abrasive portion includes one or more of a series of ridges and a removable sandpaper structure; the first body of each first gauge part is inserted into a first end of the respective slot of the slot set and the second body of each second gauge part is inserted into a second end of the respective slot of the slot set that is opposite the first end; the first body of each first gauge part is inserted into an end of the respective slot of the slot set and the second body of each second gauge part is inserted into the end of the respective slot of the slot set; a length of the second body of each second gauge part is greater than the length of the first body of each first gauge part; the first body includes a non-abrasive portion extending along the length of the first body a first distance, and wherein the abrasive portion extends along the length of the first body a second distance, the first distance being greater than or equal to the second distance; each first gauge part of the first gauge set includes an end extending from the first body, the end is tapered; and the controller is configured to move the first gauge set in a reciprocating motion when the abrasive portion of the first body is at least partially inserted into the respective slot of the slot set.

In yet another form, the present disclosure provides a method for deburring and measuring a slot set of a stator, the method includes moving a first gauge holder toward the stator so that an abrasive portion of a first body of a first gauge part secured to the first gauge holder is at least partially inserted into a respective slot of the slot set, moving the first gauge holder away from the stator so that the abrasive portion of the first body of the first gauge part is removed from the respective slot of the slot set, moving a second gauge holder toward the stator so that a second body of a second gauge part secured to the second gauge holder is at least partially inserted into the respective slot of the slot set, the second gauge holder being moved toward the stator after the abrasive portion of the first body of the first gauge part is removed from the respective slot of the slot set, and moving the second gauge holder away from the stator so that the second body of the second gauge part is removed from the respective slot of the slot set.

In variations of the method of the above paragraph, which can be implemented individually or in any combination: the abrasive portion includes one or more of a series of ridges and a removable sandpaper structure and the method further includes moving the first gauge part in a reciprocating motion when the abrasive portion of the first body is at least partially inserted into the respective slot of the slot set.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded view of an electric machine according to the principles of the present disclosure;

FIG. 2 is a perspective view of a portion of a stator of the electric machine of FIG. 1;

FIG. 3 is a perspective view of a deburring gauge system according to the principles of the present disclosure;

FIG. 4A is a schematic perspective view of one gauge part of a gauge set of the deburring gauge system of FIG. 3;

FIG. 4B is a schematic side view of one gauge part of the gauge set of the deburring gauge system of FIG. 3;

FIGS. 5A and 5B are example abrasive materials for the gauge part of the deburring gauge system of FIG. 3;

FIG. 6A is a top view of a portion of a stator having burrs within one of the slots;

FIGS. 6B-6D are cross-sectional views of a portion of the deburring gauge system of FIG. 3 measuring and deburring one slot of the stator of FIG. 6A according to the principles of the present disclosure;

FIG. 6E is a top view of the portion of the stator of FIG. 6A with the burrs removed;

FIG. 7 is a flowchart illustrating a method for measuring and deburring slots of an example stator using the deburring gauge system of FIG. 3;

FIG. 8 is a perspective view of another deburring gauge system according to the principles of the present disclosure;

FIG. 9A is a schematic perspective view of a first gauge part of the deburring gauge system of FIG. 8 for deburring slots of an example stator;

FIG. 9B is a schematic perspective view of a second gauge part of the deburring gauge system of FIG. 8 for measuring slots of an example stator; and

FIG. 10 is a flowchart illustrating a method for measuring and deburring slots of an example stator using the deburring gauge system of FIG. 8 according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

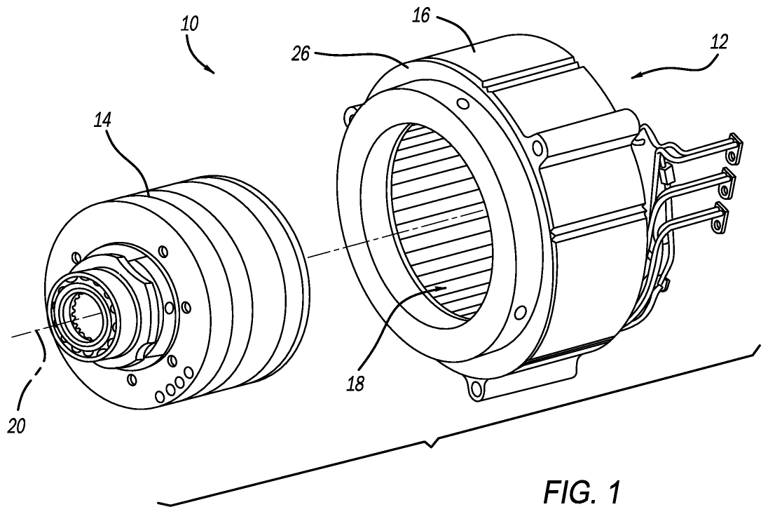

Referring to FIG. 1, an electric machine 10 may be used in a vehicle (not shown) such as a fully electric vehicle or a hybrid-electric vehicle. The electric machine 10 may be referred to as an electric motor, a traction motor, a generator, or the like. The electric machine 10 may be a permanent magnet machine, an induction machine, or the like. In the example illustrated, the electric machine 10 is a three-phase alternating current (AC) machine, though other types may be used, such as direct current (DC) machines or single-phase AC machines for example. In the example provided, the electric machine 10 is a traction motor capable of acting as both a motor to propel the vehicle and as a generator such as during regenerative braking, though the electric machine 10 may be used for other purposes as a motor and/or generator.

The electric machine 10 may be powered by a traction battery (not shown) in the vehicle. The traction battery may provide a high-voltage direct current (DC) output from one or more battery-cell arrays, sometimes referred to as battery-cell stacks, within the traction battery. An AC/DC converter (not shown) converts the high-voltage (DC) current from the traction batter to three-phase AC current. The battery-cell arrays may include one or more battery cells that convert stored chemical energy to electrical energy. The cells may include a housing, a positive electrode (cathode), and a negative electrode (anode). An electrolyte allows ions to move between the anode and cathode during discharge, and then return during recharge. Terminals allow current to flow out of the cells for use by the vehicle.

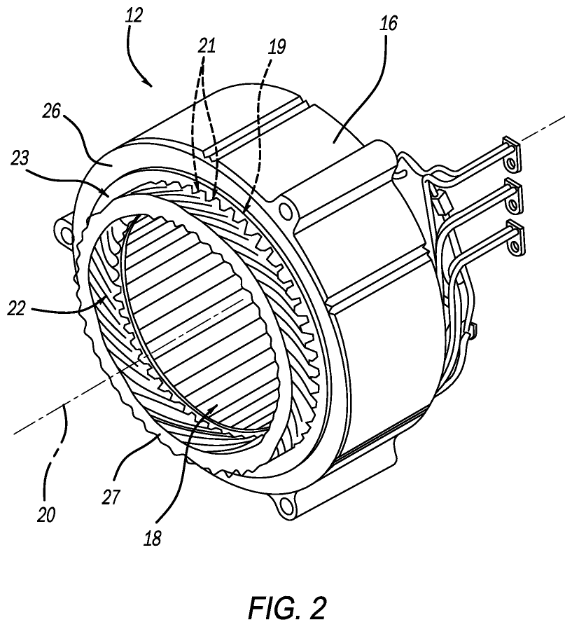

With reference to FIGS. 1 and 2, the electric machine 10 includes, inter alia, a stator 12 and a rotor 14 (FIG. 1). The stator 12 may include an iron or iron alloy stator core 16 formed by a stack of laminations. The stator core 16 defines a central cavity 18 where the rotor 14 is disposed. A shaft (not shown) may be operably connected to the rotor 14 to receive drive torque resulting from operation of the electric machine 10, i.e., output rotation of the rotor 14 about axis 20. The shaft is configured to couple with a load such as a drivetrain of the vehicle.

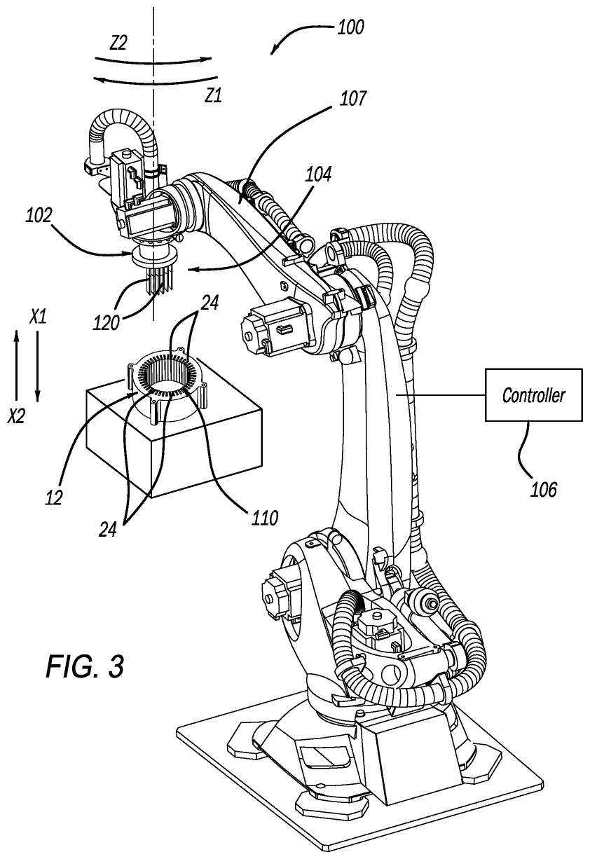

As shown in FIG. 2, windings 22 may be disposed about the stator 12 to generate an electromechanical field within the cavity 18 when energized to drive the rotor 14. The stator 12 includes a back iron 19 and a plurality of teeth 21 that extend radially inward from the back iron 19 to define a plurality of slots 24 (FIG. 3) spaced apart about a circumference of the stator 12. In the example illustrated, the slots 24 have a rectangular shape. In some forms, the slots 24 may have a circular shape, a square shape, or any other suitable shape that corresponds to the shape of the windings 22 or is otherwise configured to receive the windings 22. The windings 22 may be routed throughout the slots 24 in a serpentine fashion to create one or more winding paths to transmit current through the stator 12. In the example illustrated, end portions 27 of the windings 22 may protrude beyond an end face 26 of stator core 16 to adjoin windings in slots 24. In some forms, the windings 22 include copper hairpin windings that are routed throughout an iron alloy stator core.

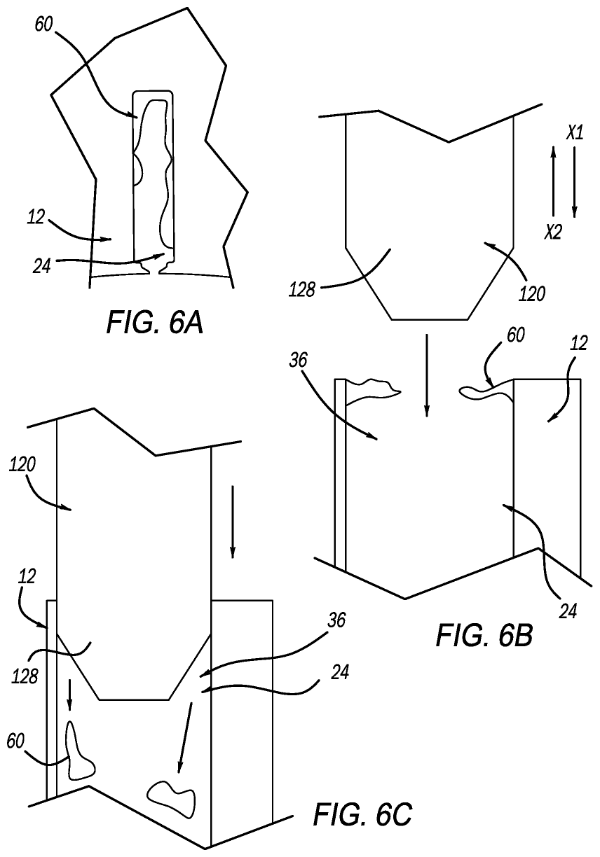

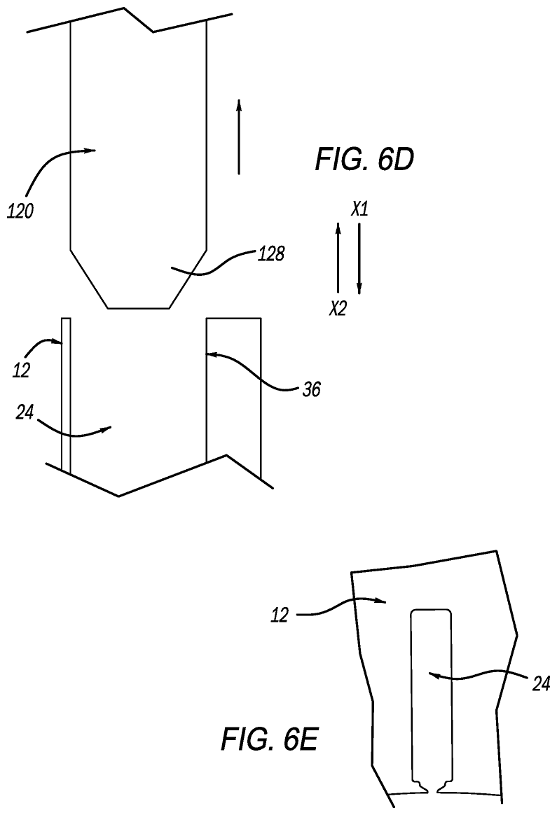

The stator 12 undergoes a manufacturing process in which insulation 23 covering at least part of the stator 12 is formed by a molding process. For example, the end face 26 of the stator core 16, including the back iron 19 and the teeth 21, may be coated by the insulation. Upon completion of the molding process, dimensions of the slots 24 are measured to provide for the slots 24 being within predetermined tolerance ranges. One or more gauges may be used to measure the dimensions of the slots 24. Furthermore, burrs 60 (FIG. 6A) may be left over from the molding process and need to be removed from the slots 24 of the stator 12. Conventionally, the burrs 60 are removed from the slots 24 of the stator 12 using a manual process.

With reference to FIG. 3, an automatic deburring gauge system 100 is provided that includes a gauge holder 102, a gauge set 104, and a controller 106. In the example illustrated, the gauge set 104 is removably coupled to the gauge holder 102. In one form, the gauge set 104 is removably coupled directly to the gauge holder 102 (e.g., the gauge set 104 is securely received in threaded apertures of the gauge holder 102). In another form, the gauge set 104 is removably coupled to the gauge holder 102 by an adapter (not shown). In one form, a robot arm 107 may be coupled to the gauge holder 102 and may include a plurality of segments connected to each other at joints, thereby allowing the robot arm 107 to have multiple degrees of freedom. In this way, the robot arm 107 may move the gauge holder 102 in a first direction X1 toward the stator 12 so that the gauge set 104 is at least partially inserted into a slot set 110 of the stator 12, and in a second direction X2 (the second direction X2 is opposite the first direction X1) away from the stator 12 so that the gauge set 104 is removed from the slot set 110 of the stator 12. In another form, not specifically shown, the gauge holder 102 may be coupled to a different type of robotic device, such as a robotic gantry for example. In the example illustrated, the first direction X1 and the second direction X2 are vertical directions. In some forms, the first direction X1 and the second direction X2 may be horizontal directions. In other forms, the robot arm 107 may move the gauge holder 102 in a vertical direction and in a horizontal direction without departing from the scope of the present disclosure. The robot arm 107 may also selectively rotate the gauge holder 102 about the axis 20 of the stator in a first rotational direction Z1 and in a second rotational direction Z2 that is opposite the first rotational direction.

The gauge set 104 is configured to be at least partially inserted into the slot set 110 of the stator 12 to deburr the slots 24 in the slot set 110 and optionally to measure the dimensions of the slots 24 in the slot set 110. The gauge set 104 includes one or more gauge parts 120. It should be understood that the number of gauge parts 120 in the gauge set 104 equal the number of slots 24 in the slot set 110. For example, if the slot set 110 includes ten slots 24 then the gauge set 104 includes ten gauge parts 120. It should also be understood that the number of slots 24 in the slot set 110 may be less than the total number of slots 24 of the stator 12. For example, the stator 12 may include twenty-four total slots 24 and the slot set 110 may include six slots 24. In this way, the gauge holder 102 inserts the gauge set 104 into the stator 12 four separate times in order to deburr (and optionally measure the dimensions of the slots 24) every slot 24 in the stator 12 as will be described in more detail below. It should also be understood that slots 24 of the slot set 110 may equal the total number of slots 24 of the stator 12. For example, the slot set 110 may include twenty-four slots 24. In this way, the gauge holder 102 inserts the gauge set 104 into the stator 12 one time in order to deburr (and optionally measure the dimensions of the slots 24) every slot 24 in the stator 12.

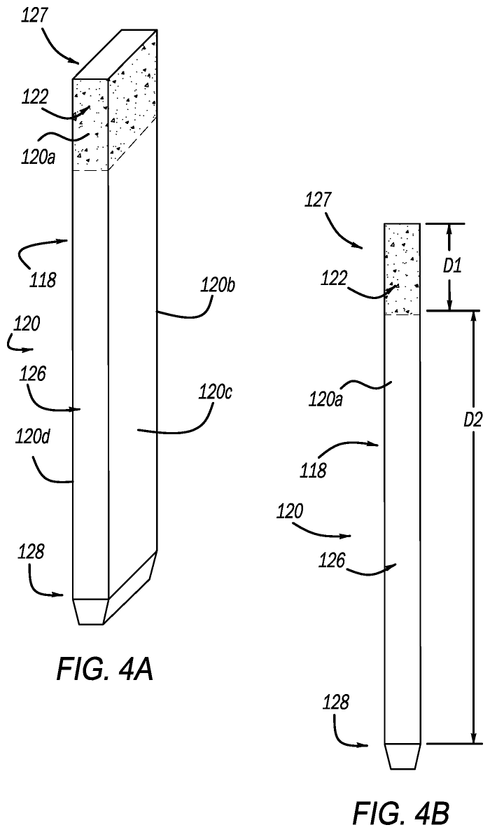

With reference to FIGS. 4A and 4B, each gauge part 120 has a shape that corresponds to the shape of the slot 24 and a length that corresponds to or is longer than the length of the slot 24. In the example illustrated, each gauge part 120 has a generally rectangular shape that corresponds to the rectangular shaped slot. Each gauge part 120 includes a body 118 having a plurality of sides 120a, 120b, 120c, 120d. The side 120a is opposite the side 120b and perpendicular to the sides 120c, 120d. The side 120c is opposite the side 120d. The distances between and angles between the sides 120a, 120b, 120c, 120d are maintained at a predetermined tolerance equal to or stricter than the predetermined tolerance ranges of the slots 26. The body 118 also includes an abrasive portion 122 (shown schematically) extending along a length of the body 118 a first distance D1 and a non-abrasive portion 126 extending along the length of the body 118 a second distance D2. In the example illustrated, the second distance D2 is greater than the first distance D1. In some forms, the first distance D1 may be greater than or equal to the second distance D2.

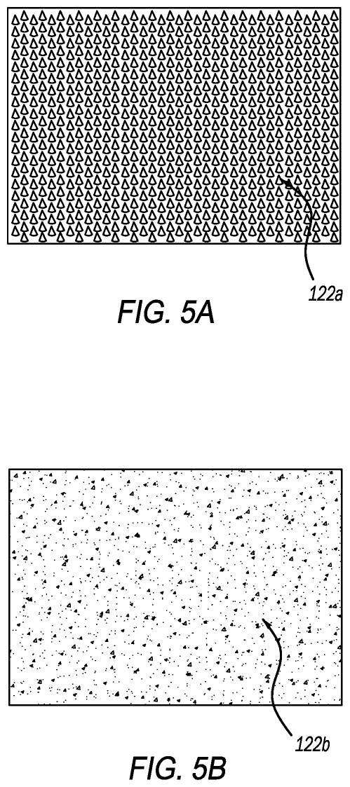

In the example illustrated, the abrasive portion 122 is formed around the entire body 118 (i.e., the abrasive portion 122 is formed on each of the sides 120a, 120b, 120c, 120d of the body 118) and is configured to deburr a respective slot 24 of the stator 12. In some forms, the abrasive portion 122 is partially formed around the entire body 118 (i.e., the abrasive portion 122 is formed on one or more sides 120a, 120b, 120c, 120d of the body 118). In the example illustrated, the abrasive portion 122 is located at an end 127 of the body 118. In some forms, the abrasive portion 122 may located along a center portion of the body 118. In other forms, the body 118 may include a plurality of abrasive portions that are spaced apart from each other along the length of the body 118. The abrasive portion 122 includes one or more abrasive materials configured to deburr the respective slot 24 (i.e., polish and/or clean surfaces defining the respective slot 24). In one example, as shown in FIG. 5A, the abrasive material 122a includes a series of ridges. In another example, as shown in FIG. 5B, the abrasive material 122b includes removable sandpaper sheet or structure wrapped at least partially around the body 118. In yet another example, the abrasive portion includes a sharp cutting edge (not shown) formed as part of the body 118. In some forms, the gauge part 120 may be replaced with a reamer (not shown) to polish and/or clean surfaces defining the respective slot 24. Each gauge part 120 may also include an end 128 that is optionally tapered in the first direction X1. In this way, the tapered end 128 is configured to deburr the surfaces defining the respective slot 24 prior to the abrasive portion 122 providing fine removal/polishing of the surfaces. In some forms, the non-abrasive portion 126 has a smooth surface that is not meant to clean or polish the surfaces defining the respective slot 24.

With reference back to FIG. 3, the controller 106 is in communication with the robot arm 107 and may control operations of the robot arm 107 based on data received and/or inputted by a user. In one example, the controller 106 is in communication with the robot arm 107 using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

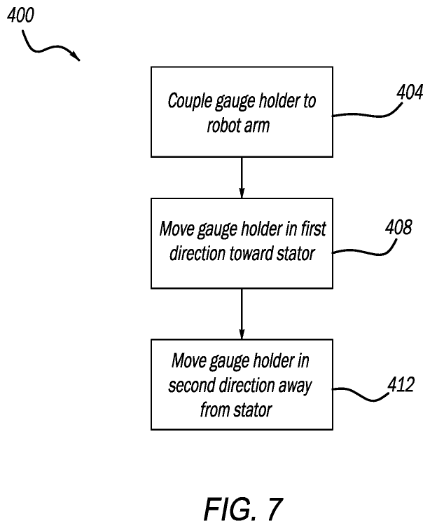

Referring to FIGS. 6A-6E and 7, an example control algorithm 400 for deburring and optionally measuring a slot set 110 (FIG. 3) of a stator 12 is illustrated. That is, after the stator 12 undergoes the molding process, the stator 12 may have burrs 60 within one or more of the slots 24 (FIG. 6A). At 404, the gauge holder 102 (FIG. 3) with the gauge set 104 (FIG. 3) secured thereto is coupled to the robot arm 107 (FIG. 3). At 408, the control algorithm, using the controller 106, instructs the robot arm 107 to move the gauge holder 102 in the first direction X1 (FIGS. 6B and 6C) toward the stator 12 so that the abrasive portion 122 of the body 118 of each gauge part 120 is at least partially inserted into the respective slot 24 of the slot set 110 of the stator 12 (FIG. 6B). In this way, each gauge part 120 removes burrs 60 from the respective slot 24 (i.e., the tapered end 128 of each gauge part 120 and the abrasive portion 122 of each gauge part 120 remove burrs from the slots 24 of the stator 12) while also optionally measuring the dimensions of the slot 24. In some configurations, the controller 106 is configured to instruct the robot arm 107 to move the gauge set 104 in a reciprocating motion when the abrasive portion 122 of each gauge part 120 is at least partially inserted into the respective slot 24 of the slot set 110 to facilitate the removal of burrs 60 from the slots 24 of the stator 12.

Each gauge part 120 is inserted all the way into the respective slot 24 with a force and stroke such that the tapered end 128 (and optionally, the abrasive portion 122) of each gauge part 120 reaches an end (not shown) of the respective slot 24 (the end of the respective slot 24 is opposite end 36 of respective slot 24 where the gauge part 120 is inserted). If the force needed to insert each gauge part 120 all the way into the respective slot 24 as described above is below a predetermined threshold, then the dimensions of the slots 24 are within a predetermined tolerance range. If the force needed to insert each gauge part 120 all the way into the respective slot 24 as described above exceeds a predetermined threshold, then the dimensions of the slots 24 may not be within the predetermined tolerance range.

At 412, the control algorithm, using the controller 106, instructs the robot arm 107 (FIG. 1) to move the gauge holder 102 in the second direction X2 (FIG. 6D) away from the stator 12 so that each gauge part 120 is removed from the respective slot 24 of the slot set 110 of the stator 12 and the respective slot 24 is free of burrs 60 (FIG. 6E).

If the slot set 110 includes the total number of slots 24 of the stator 12 then the gauge holder 102 inserts the gauge set 104 into the stator 12 one time in order to deburr (and optionally measure) every slot 24 in the stator 12. If the number of slots 24 in the slot set 110 is less than the total number of slots 24 of the stator 12 then the controller 106 instructs the robot arm 107 to rotate the gauge holder 102 such that the gauge set 104 is inserted into a different slot set 110 to deburr (and optionally measure) the slot set 110. This process is repeated until every slot 24 of the stator 12 is deburred and optionally measured. For example, if the stator 12 includes forty-eight total slots 24 and the slot set 110 includes twelve slots 24, then the gauge holder 102 inserts the gauge set 104 into four different slot sets 110 in order to deburr (and optionally measure) every slot 24 in the stator 12. In an alternative form, not specifically shown, the stator 12 may be on a rotatable platform and the controller 106 may control the platform to rotate the stator 12 to deburr (and optionally measure) the next slot set 110. The deburring gauge system 100 of the present disclosure enhances the efficiency of deburring and optionally measuring the stator 12 of the electric machine 10. It should also be understood that sensors (not shown) located on the gauge parts 120 or associated with the robot arm 107 may measure force needed to insert gauge parts 120 all the way into the slots 24 of the stator 12.

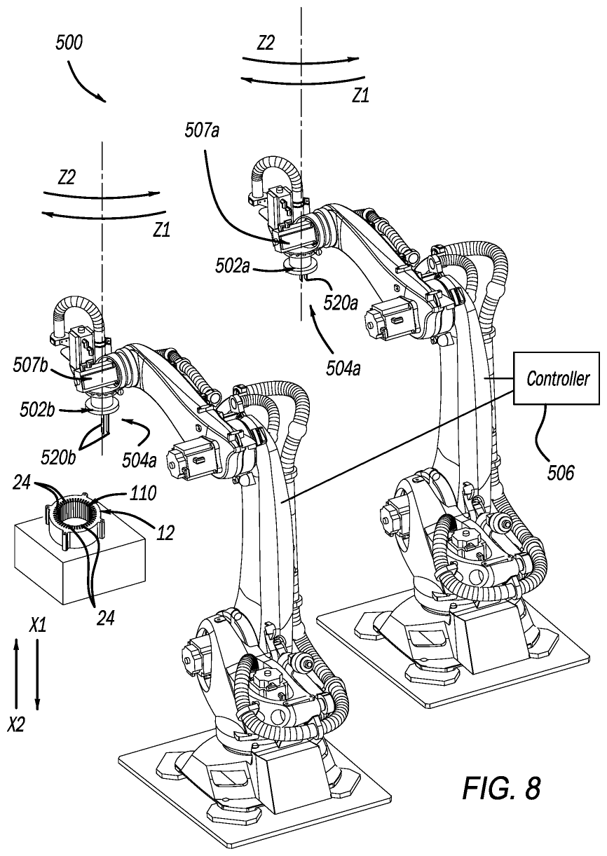

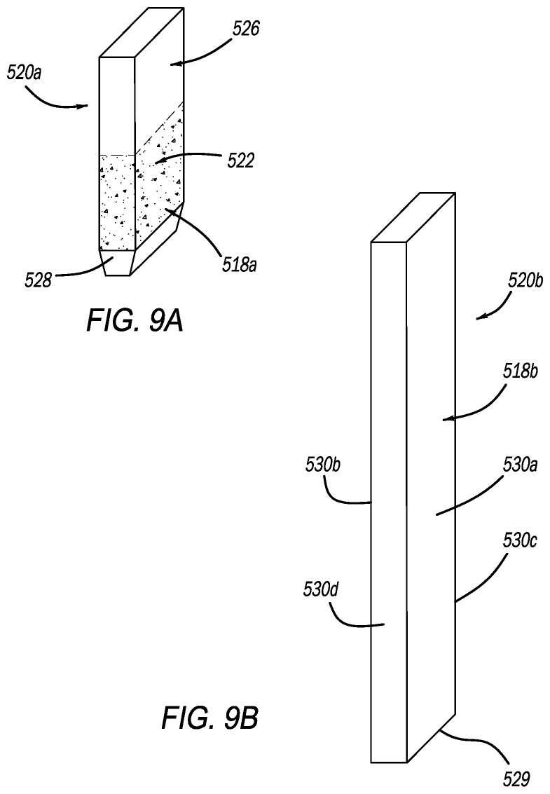

With reference to FIGS. 8, 9A, and 9B another deburring gauge system 500 is provided. The structure and function of the deburring gauge system 500 may be similar or identical to that of deburring gauge system 100 described above, apart from any exception noted below. The deburring gauge system 500 includes a first gauge holder 502a, a second gauge holder 502b, a first gauge set 504a, a second gauge set 504b, and a controller 506.

The first gauge set 504a is removably coupled to the first gauge holder 502a. A first robot arm 507a may be coupled to the first gauge holder 502a and may move the first gauge holder 502a in a first direction X1 toward the stator 12 so that the first gauge set 504a is at least partially inserted into a slot set 110 of the stator 12, and in a second direction X2 away from the stator 12 so that the first gauge set 504a is removed from the slot set 110 of the stator 12. The first robot arm 507a may also rotate the first gauge holder 502a in a first rotational direction Z1 and in a second rotational direction Z2 that is opposite the first rotational direction.

The first gauge set 504a is configured to be at least partially inserted into the slot set 110 of the stator 12 to deburr the slots 24 in the slot set 110. The first gauge set 504a includes one or more gauge parts 520a (one shown in FIG. 9A). It should be understood that the number of gauge parts 520a in the gauge set 504a equal the number of slots 24 in the slot set 110. Each gauge part 520a has a shape that corresponds to the shape of the slot 24. With reference to FIG. 9A, each gauge part 520a includes a body 518a having an abrasive portion 522 and a non-abrasive portion 526. The structure and function of the abrasive portion 522 may be similar or identical to that of the abrasive portion 122 of gauge part 120 described above, and therefore, will not be described again in detail. Each gauge part 520a may also include an end 528 extending from the body 518a that is optionally tapered. The structure and function of the tapered end 528 may be similar or identical to that of tapered end 128 of the gauge part 120 described above, and therefore, will not be described again in detail.

With reference back to FIG. 8, the second gauge set 504b is removably coupled to the second gauge holder 502b. A second robot arm 507b may be coupled to the second gauge holder 502b and may move the second gauge holder 502b in the first direction X1 toward the stator 12 so that the second gauge set 504b is at least partially inserted into the slot set 110 of the stator 12, and in the second direction X2 away from the stator 12 so that the second gauge set 504b is removed from the slot set 110 of the stator 12. The second robot arm 507b may also rotate the second gauge holder 502b in the first rotational direction Z1 and in the second rotational direction Z2 that is opposite the first rotational direction.

The second gauge set 504b is configured to be at least partially inserted into the slot set 110 of the stator 12 to measure the dimensions of the slots 24 in the slot set 110. The second gauge set 504b includes one or more gauge parts 520b (FIG. 9B). It should be understood that the number of gauge parts 520b in the second gauge set 504b equal the number of slots 24 in the slot set 110. Each gauge part 520b has a shape that corresponds to the shape of the slot 24 and a length that corresponds to the length of the slot 24. With reference to FIG. 9B, each gauge part 520b includes a body 518b having a plurality of sides 530a, 530b, 530c, 530d. The side 530a is opposite the side 530b and perpendicular to the sides 530c, 530d. The side 530c is opposite the side 530d. In the example illustrated, the body 518b of each gauge part 520b has a length that is greater than a length of the body 518a of each gauge part 520a. In some forms, the length of the body 518b of each gauge part 520b may be equal to the length of the body 518a of each gauge part 520a. The body 518b of each gauge part 520b also does not include an abrasive portion.

With reference to FIG. 8, the controller 506 is in communication with the first and second robot arms 507a, 507b and may control operations of the first and second robot arms 507a, 507b based on data received. In one example, the controller 506 is in communication with the first and second robot arms 507a, 507b using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

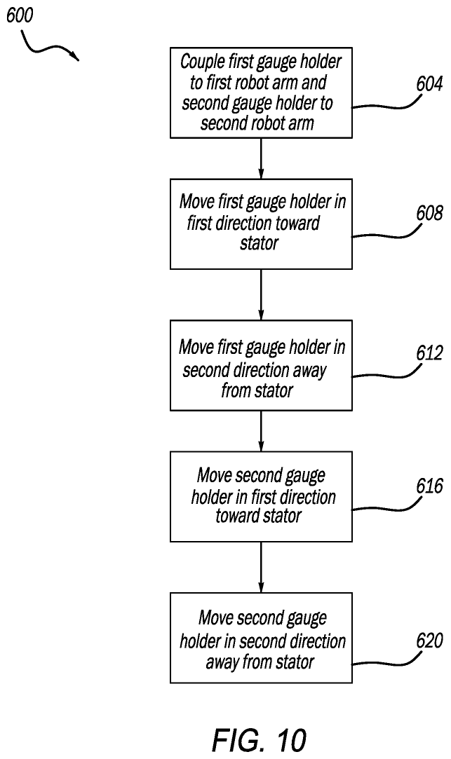

Referring to FIG. 10, an example control algorithm 600 for deburring and measuring a slot set 110 of a stator 12 is illustrated. At 604, the first gauge holder 502a with the first gauge set 504a secured thereto is coupled to the first robot arm 507a and the second gauge holder 502b with the second gauge set 504b secured thereto is coupled to the second robot arm 507b. At 608, the control algorithm, using the controller 506, instructs the first robot arm 507a to move the first gauge holder 502a in the first direction X1 toward the stator 12 so that the abrasive portion 522 of the body 518a of each gauge part 520a is at least partially inserted into the respective slot 24 of the slot set 110 of the stator 12. In this way, the tapered end 528 of each gauge part 520a and the abrasive portion 522 of each gauge part 520a remove burrs from the stator 12.

At 612, the control algorithm, using the controller 506, instructs the first robot arm 507a to move the first gauge holder 502a in the second direction X2 away from the stator 12 so that each gauge part 520a is removed from the respective slot 24 of the slot set 110 of the stator 12. After the first gauge holder 502a is moved in the second direction X2 so that each gauge part 520a is removed from the respective slot 24 of the slot set 110, the debris is removed from the stator 12. That is, the debris may be removed from the stator 12 using suction or blowing the debris off to inhibit residuals from the deburring to interfere with subsequent steps such as measurement or winding insertion steps. At 616, the control algorithm, using the controller 506, instructs the second robot arm 507b to move the second gauge holder 502b in the first direction X1 toward the stator 12 so that the body 518b of each gauge part 520b is at least partially inserted into the respective slot 24 of the slot set 110 of the stator 12. Each gauge part 520b of the second gauge set 504b is inserted into the stator 12 after each gauge part 520a of the first gauge set 504a is removed from the stator 12.

Each gauge part 520b is inserted all the way into the respective slot 24 with a force such that the end 529 of each gauge part 520b reaches the end (not shown) of the respective slot 24. If the force needed to insert each gauge part 520b all the way into the respective slot 24 as described above is below a predetermined threshold, then the dimensions of the slots 24 are within a predetermined tolerance range. If the force needed to insert each gauge part 520b all the way into the respective slot 24 as described above exceeds a predetermined threshold, then the dimensions of the slots 24 may not be within the predetermined tolerance range. It should be understood that the force needed to insert each gauge part 520b all the way into the respective slot 24 may be less than the force needed to insert each gauge part 120 described above into the respective slot 24. That is, less force may be needed to insert gauge parts 520b into the slots 24 when the slots 24 are first deburred by a previous deburring step (i.e., step 608) compared to when the deburring and measuring is happening simultaneously as described above with regard to gauge parts 120 (i.e., step 408). It should also be understood that sensors (not shown) located on the gauge parts 520b or associated with the second robot arm 507b may measure force needed to insert gauge parts 520b all the way into the slots 24 of the stator 12.

At 620, the control algorithm, using the controller 506, instructs the second robot arm 507b to move the second gauge holder 502b in the second direction X2 away from the stator 12 so that each gauge part 520b is removed from the respective slot 24 of the slot set 110 of the stator. In the example illustrated, each gauge part 520a of the first gauge set 502a and each gauge part 520b of the second gauge set 502b are both inserted into the same end of the respective slot 24 of the slot set 110. In some forms, each gauge part 520a of the first gauge set 502a is inserted into one end of the respective slot 24 of the slot set 110 and each gauge part 520b of the second gauge set 502b is inserted into another end of the respective slot 24 of the slot set 110 that is opposite the end. Each gauge part 520b of the second gauge set 502b may be inserted into the other end of the respective slot 24 of the slot set 110 after the first gauge set 502a is removed from the slot set 110.

In another form, a deburring gauge system (not shown) may include one robot (not shown) which switches between a first gauge holder having a first gauge set coupled thereto and a second gauge holder having a second gauge set coupled thereto instead of each of the first and second gauge holders being coupled to a respective robot arm as described above.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A deburring gauge system for a stator, the deburring gauge system comprising:
a gauge set configured to be at least partially inserted into a slot set of the stator, each first gauge part of the gauge set includes a first body having a first cross-sectional shape that corresponds to a second cross-sectional shape of a respective first slot of the slot set, the first body of each first gauge part includes an abrasive portion extending along a length of the first body;
a gauge holder secured to the gauge set; and
a controller in communication with the gauge holder and configured to:
move the gauge holder in a first direction toward the stator so that the abrasive portion of the first body is at least partially inserted into the respective first slot of the slot set of the stator; and
move the gauge holder in a second direction away from the stator so that the abrasive portion of the first body is removed from the respective first slot of the slot set of the stator.

2. The deburring gauge system of claim 1, wherein the abrasive portion includes a series of ridges or a removable sandpaper structure.

3. The deburring gauge system of claim 1, wherein the abrasive portion includes a series of ridges and a removable sandpaper structure.

4. The deburring gauge system of claim 1, wherein each first gauge part of the gauge set includes an end extending from the first body, and wherein the end is tapered in the first direction.

5. The deburring gauge system of claim 1, wherein the controller is configured to move the gauge set in a reciprocating motion when the abrasive portion of the first body is at least partially inserted into the respective first slot of the slot set of the stator.

6. The deburring gauge system of claim 1, wherein the first body further includes a non-abrasive portion extending along the length of the first body, and wherein the abrasive portion extends along the length of the first body a first distance and the non-abrasive portion extends along the length of the first body a second distance that is greater than the first distance.

7. The deburring gauge system of claim 1, wherein the first cross-sectional shape of each first gauge part of the gauge set is rectangular.

8. The deburring gauge system of claim 1, wherein the gauge set further includes second gauge parts secured to another gauge holder, each second gauge part configured to be inserted into the respective first slot of the slot set, each second gauge part includes a second body having a third cross-sectional shape that corresponds to the second cross-sectional shape of the respective first slot of the slot set.

9. The deburring gauge system of claim 8, wherein a length of the second body of each second gauge part is greater than the length of the first body of each first gauge part.

10. A deburring gauge system for a stator, the deburring gauge system comprising:
a first gauge set configured to be at least partially inserted into a slot set of the stator, each first gauge part of the first gauge set includes a first body having a first cross-sectional shape that corresponds to a second cross-sectional shape of a respective slot of the slot set, the first body of each first gauge part includes an abrasive portion extending along a length of the first body;
a second gauge set configured to be at least partially inserted into the slot set of the stator, each second gauge part of the second gauge set includes a second body having a third cross-sectional shape that corresponds to the second cross-sectional shape of the respective slot of the slot set;
a first gauge holder secured to the first gauge set;
a second gauge holder secured to the second gauge set; and
a controller in communication with the first gauge holder and the second gauge holder, the controller configured to:
move the first gauge holder toward the stator so that the abrasive portion of the first body of each first gauge part is at least partially inserted into the respective slot of the slot set;
move the first gauge holder away from the stator so that the abrasive portion of the first body of each first gauge part is removed from the respective slot of the slot set;
move the second gauge holder toward the stator so that the second body of each second gauge part is at least partially inserted into the respective slot of the slot set, the second gauge holder being moved toward the stator after the abrasive portion of the first body of each first gauge part is removed from the respective slot of the slot set; and
move the second gauge holder away from the stator so that the second body of each second gauge part is removed from the respective slot of the slot set.

11. The deburring gauge system of claim 10, wherein the abrasive portion includes one or more of a series of ridges and a removable sandpaper structure.

12. The deburring gauge system of claim 10, wherein the first body of each first gauge part is inserted into a first end of the respective slot of the slot set and the second body of each second gauge part is inserted into a second end of the respective slot of the slot set that is opposite the first end.

13. The deburring gauge system of claim 10, wherein the first body of each first gauge part is inserted into an end of the respective slot of the slot set and the second body of each second gauge part is inserted into the end of the respective slot of the slot set.

14. The deburring gauge system of claim 10, wherein a length of the second body of each second gauge part is greater than the length of the first body of each first gauge part.

15. The deburring gauge system of claim 10, wherein the first body includes a non-abrasive portion extending along the length of the first body a first distance, and wherein the abrasive portion extends along the length of the first body a second distance, the first distance being greater than or equal to the second distance.

16. The deburring gauge system of claim 10, wherein each first gauge part of the first gauge set includes an end extending from the first body, and wherein the end is tapered.

17. The deburring gauge system of claim 10, wherein the controller is configured to move the first gauge set in a reciprocating motion when the abrasive portion of the first body is at least partially inserted into the respective slot of the slot set.

18. A method for deburring and measuring a slot set of a stator, the method comprising:
moving a first gauge holder toward the stator so that an abrasive portion of a first body of a first gauge part secured to the first gauge holder is at least partially inserted into a respective slot of the slot set;
moving the first gauge holder away from the stator so that the abrasive portion of the first body of the first gauge part is removed from the respective slot of the slot set;
moving a second gauge holder toward the stator so that a second body of a second gauge part secured to the second gauge holder is at least partially inserted into the respective slot of the slot set, the second gauge holder being moved toward the stator after the abrasive portion of the first body of the first gauge part is removed from the respective slot of the slot set; and
moving the second gauge holder away from the stator so that the second body of the second gauge part is removed from the respective slot of the slot set.

19. The method of claim 18, wherein the abrasive portion includes one or more of a series of ridges and a removable sandpaper structure.

20. The method of claim 18, further comprising moving the first gauge part in a reciprocating motion when the abrasive portion of the first body is at least partially inserted into the respective slot of the slot set.
